(19) United States
(12) Patent Application Publication
(10) Pub. No.: US 2006/0111517 A1
(43) Pub. Date: May 25, 2006

(54) Recognition layers made of hydrogel based on polyacrylamide for use in biosensor technology

(76) Inventors: Hans-Dieter Feucht, Renningen (DE); Walter Gumbrecht, Herzogenaurach (DE); Manfred Stanzel, Erlangen (DE); Heinrich Zeininger, Obermichelbach (DE)

Correspondence Address: HARNESS, DICKEY & PIERCE, P.L.C., P.O.BOX 8910, RESTON, VA, 20195, US

(21) Appl. No.: 10/523,929

(22) PCT Filed: Jul. 23, 2003
(86) PCT No.: PCT/DE03/02483

§ 371 Date: Oct. 3, 2005

(30) Foreign Application Priority Data
Aug. 8, 2002 (DE) 102 36 459.1

(51) Int. Cl. C08F 220/56

(52) U.S. Cl. 525/329.4

(57) ABSTRACT

A hydrophilic immobilization layer for biosensors is made of a radically cross-linkable hydrogel based on polyacraylamide. The starting composition includes acrylamide, cross-linkers, radical initiator(s), at least one comonomer having reactive linker groups and optionally may include softeners. Alternatively, the inventive layer may be of a photostructured hydrogel based on polyacrylamide. The starting composition includes acrylamide, cross-linkers, photoinitiators, at least one film former, at least one comonomer having reactive linker groups and optionally may include softeners.

This application is the national phase under 35 U.S.C. § 371 of PCT International Application No. PCT/DE2003/002483 which has an International filing date of Jul. 23, 2003, which designated the United States of America and which claims priority on German Patent Application number DE 102 36 459.1 filed Aug. 8, 2002, the entire contents of which are hereby incorporated herein by reference.

### FIELD OF THE INVENTION

The present invention generally relates to an Immobilization layer for biosensors as well as to its use to create biosensor recognition layers, especially for creating what are known as DNA chips.

### BACKGROUND OF THE INVENTION

Biosensors, in which a biological recognition system is linked to a physical transducer, are increasingly being used in modern biological analysis technology but also in medical diagnostics. Recognition systems refer to topological recognition molecules such as antibodies, enzymes, nucleo acids and such like which are bound via what is known as an immobilization layer to a carrier (transducer). Calorimetric, piezoelectric, optical and electrochemical principles are primarily used as transducers.

The recognition systems or originally the immobilization layers respectively, are immobilized in this case mostly in approximately two-dimensional layers on the transducer systems. The recognition molecules can be immobilized by covalent bindings, by an affinity reciprocal effect but also by hydrophile/hydrophobe reciprocal effects. For reasons of stability, covalent bindings are preferred. However, the formation of stable complexes, for example Biotin/Avidin, are also successfully used. A good overview of the structure of approximately two-dimensional biological recognition layers can be found in I. Willner, E. Katz:“Redox protein layers on conductive carriers—system for bioelectronic applications” in Angew. Chem. (Applied Chemistry) 2000, 112, pp. 1230-69.

With transducer surfaces which contain NH or OH groups the biological function carriers, i.e. the recognition molecules, are frequently immobilized by Alkoxysilanes which contain so-called linker groups, that is with the aid of Cyanurchloride or Carbodiimide. To equip transducer surfaces containing gold, recognition molecules labeled with thiolalkyl are used which are immobilized via sulfur-gold bonds in the form of so-called self-assembly-layers on the transducer surface. An interesting approach to the immobilization of Nuclein acids on transducer surfaces is the photochemically supported synthesis of Affymetrix (light-directed spatially addressable parallel chemical synthesis, S. P. A. Fodor et al., Science 251, 767-773 (1991)).

To increase the sensitivity of biosensors as well as to optimize the reproducibility of the measurement results obtained by doing so, it makes sense to use three-dimensional immobilization layers for the biological recognition molecules. The German company Schleicher & Schüll GmbH is offering DNA chips under the name FAST™ Slides, in which the capture oligos are immobilized in a three-dimensional nitrocellulose membrane (BioMolecular Screening, Catalog 2001, intern. Edit. Schleicher & Schüll).

In WO 00/43539, the construction of a three-dimensional DNA recognition layer through immobilization of the DNA capture probes in the form of polymer brushes is described.

Timofeev et al. describe a chemically modified radically cross-linked polyacrylamide which can be used for example for the immobilization of capture oligos (E. N. Timofeev et al., Regioselective Immobilization of Short Oligonucleotides to Acrylic Copolymer Gels, Nucleic Acids Research, 1966, Vol. 24, No. 16, 3142-3148). Here Amino or Aldehyde groups are used coupling groups in the hydrogel. Aldehyde or Amino functionalized capture oligos can be immobilized covalently at these coupling groups under reductive reaction conditions. thus, as well as the actual coupling reaction between Amino and Aldehyde group or vice versa, an additional reduction layer is required using a reduction device/method. Further methods described by Timofeev et al. for chemical activation of the cross-linked Polyacrylamide also require additional reaction steps in the Polymer matrix.

### SUMMARY OF THE INVENTION

An object of an embodiment of the present invention is the creation of a hydrophilic immobilization layer for biosensor applications based on a hydrogels, and/or the use of such immobilization layers for creating recognition layers through covalent coupling in of biological recognition molecules.

An embodiment of the present invention may achieve an object by using radically cross-linked or photostructured hydrogels as the immobilization layer. Such hydrogels are described in the German Patent Application “Radically cross-linkable composition for creating a hydrogel layer” or “Photostructurable composition for creating a hydrogel layer” (File reference yet known) written by the applicant.

An object of an embodiment of the present invention may thus simply be a hydrophilic immobilization layer for biosensors made of a radically cross-linked hydrogel based on Polyacrylamide, where the initial composition comprises Acrylamide, cross-linkers, radical linitiators, at least one comonomer with reactive linker groups and where necessary softeners or other additives.

An object of an embodiment directed to a compound may also be a hydrophilic immobilization layer made of a photostructured hydrogel based on Polyacrylamide, where the initial compound comprises Acrylamide, cross-linking means, photo initiators, at least one film binder, at least one comonomer with reactive linker groups and where necessary softeners or other additives.

### DETAILED DESCRIPTION OF THE EXEMPLARY EMBODIMENTS

The inventive systems, in an embodiment, allow the construction of sensor arrays with biological recognition molecules in a three-dimensional matrix at a high level of integration density.

Preferred embodiments or compositions of the hydrophilic immobilization layers may further be produced.

Further components which improve or even guarantee the mixability of the monomers and the initiators can be added to the compositions if necessary. Commercially-available additives can be used to reduce the surface tension.

After layering on a transducer system and thermal or photo cross-linking or photopolymerization or photostructuring or polymerization structuring, a water-swellable hydrogel is obtained in which, by using the linker groups, topological or chemical recognition molecules for analytical or diagnostic applications can be coupled in while retaining their functional capabilities. An object of an embodiment of the present invention may consequently also be to use the immobilization layers to produce biosensor recognition layers through (covalent) coupling in or Immobilizing off chemical or biological recognition molecules, where the recognition molecules are preferably capture oligonucleotides.

Basically the initial composition for creating the hydrogel layer (immobilization layer) can be applied with all modern layering technologies to the suitable carriers. Preferably however spin coating as well as dispensing is employed.

The properties of the hydrogel layer to be created as regards hydrophile, cross-linking density, water-swellability, etc. can be varied over wide ranges by the type of initial components used, their relationship to each other and in the final analysis the type of layer formation.

The hydrogel matrix can be adapted to the biological recognition molecules to be used, especially with regard to the cross-linking density. The cross-linking density is controlled by the type and concentration of the cross-linking molecules used, such as Acryl and/or Methacryl compounds, especially Methylenbis(meth)acrylamide and/or Dimethacrylic acid esters, such as Tetraethyleneglycoldimethacrylate.

The hydrogel mixture can also be adapted to the coating process preferred for the specific application purpose.

For spin-coating one of the methods in question is to use a polymer film former such as Polyvinylpyrrolidon, Polyacrylamide and/or Polyhydroxymethacrylate. Another is to use high-boiling point solvents such as Ethylene glycol, for the hydrogel mixture, which do not vaporize completely on spin coating and thus remain as softeners in the layer. The residual solvent content can then be explicitly further reduced by a prebake step before cross-linking and thereby the polymerization yields or the resulting layer thickness controlled. If necessary further softener systems, such as Diethyleneglycol and/or Triethyleneglycol, can be added.

For layer formation by dispensing the hydrogel mixture is applied in solution depending on the transducer dimensions in drops of a few microliters up to one nanoliter in size. For dispensing high-temperature solvents which exhibit a sufficiently long lifetime of the drop at the tip of the dispensing channels are used. Thus, the dosing and deposition of the drop are reproducable. On the other hand the boiling point of the solvent may not be too high in order to allow a sufficiently rapid evaporation of the solvent from the deposited drop.

If necessary annealing step for controlling the residual solvent content may be required. In accordance with an embodiment of the invention Dimethylformamide and/or Ethyleneglycol are preferably used for dispensing the hydrogel mixture.

The hydrogel mixture can be applied in layer or spot form on transducer or carrier surfaces made of metal, glass, silicon, silicon dioxide, silicon nitride or plastic. Surfaces with a topography that consists of different materials, for example. Interdigital electrode arrays on Silicon nitride as passivization can also be coated. The coating of surfaces thus also includes the coating of inner surfaces of micrchannels or nanotubes. The surfaces to be coated are if necessary coated with an adhesion promoter.

The polymerization and cross-linking of the hydrogel layer is undertaken by thermal or UV initiation. With UV initiation the hydrogel layer can also be structured by contact or proximity illumination through a mask. The hydrogel layer operates here like a negative resist. Polymerization and cross-linking are undertaken in the radiated area. There is no reaction in the darkened areas. The hydrogel mixture located here is removed from the substrate again in a development step. Auxiliary components such as Polymer film formers or softeners can be removed by extraction from the cross-linked hydrogel layer. This step can under some circumstances be undertaken simultaneously with the actual equipping step.

The biological or chemical recognition systems are preferably applied from an aqueous solution, an aqueous buffer solution or mixtures of polar solvents with water onto the immobilization layer. They are applied by drops or by spotting/dispensing. In nanotubes or microchannels the solution can also be applied with the biological or chemical recognition molecules to the cross-linked hydrogel layer by transport through the fluid system itself. For precisely targeted loading of measuring spots cross-linked hydrogel spots which are surrounded by a protective ring are advantageously used.

For covalent coupling of the biological or chemical recognition molecules which are provided with a coupling group suitable for the linker group present in the cross-linked hydrogel an annealing step may be required, depending on reactivity. To prevent the hydrogel layer drying out during the coupling reaction operations can be carried out in a climate-controlled chamber. Aminoalkyl groups are especially suitable for coupling to the Epoxide and Maleic acid anhydride linker groups.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. Hydrophilic immobilization layer for biosensors made of a radically cross-linked hydrogel based on polyacrylamide, wherein the initial composition comprises acrylamide, *cross-linkers, at least one radical initiätor, and at least one comonomer with reactive linker groups.

2. Hydrophilic immobilization layer made of a photostructured hydrogel, based on polyacrylamide, wherein the initial composition comprises acrylamide, *cross-linkers, at least one photoinitiätor, at least one film former, and at least one comonomer with reactive linker groups.

3. Hydrophilic immobilization layer in accordance with claim 1, wherein the cross-linkers include at least one of an acrylic and methacrylic compound.

4. Hydrophilic immobilization layer in accordance with claim 3, wherein the cross-linkers include at least one of Methylenebis(meth)acrylamide and Dimethacryl acid ester.

5. Hydrophilic immobilization layer in accordance with claim 1, wherein the at least one comonomer with reactive linker groups includes at least one of Maleic acid anhydride and Glycidyl(meth)acrylate.

6. Hydrophilic immobilization layer in accordance with claim 13, wherein the softeners include at least one of Mono, Di and Triethyleneglycol.

7. Hydrophilic immobilization layer in accordance with claim 1, wherein the initial composition is present in a polar solvent mixable with water.

8. Hydrophilic immobilization layer in accordance with claim 7, wherein the solvent is Dimethylformamide.

9. Hydrophilic immobilization layer in accordance with claim 2, wherein the film former includes at least one of Polyvinylpyrolidone, Polyacrylamide and Polyhydroxymethacrylate.

10. Hydrophilic immobilization layer in accordance with claim 1, wherein the layer is created on at least one of transducer and carrier surfaces made from at least one of metal, glass, silicon, silicon dioxide, silicon nitride, plastic and on surfaces with topography.

11. A method, comprising:
using the immobilization layer of claim 1 to produce biosensor recognition layers through at least one of coupling in and Immobilization of chemical or biological recognition molecules.

12. The method in accordance with claim 11, wherein the recognition molecules are capture oligonucleotides.

13. Hydrophilic immobilization layer in accordance with claim 1, wherein the initial composition further comprises softeners.

14. Hydrophilic immobilization layer in accordance with claim 2, wherein the initial composition further comprises softeners.

15. Hydrophilic immobilization layer in accordance with claim 2, wherein the cross-linkers include at least one of an acrylic and methacrylic compound.

16. Hydrophilic immobilization layer in accordance with claim 15, wherein the cross-linkers include at least one of Methylenebis(meth)acrylamide and Dimethacryl acid ester.

17. Hydrophilic immobilization layer in accordance with claim 2, wherein the at least one comonomer with reactive linker groups includes at least one of Maleic acid anhydride and Glycidyl(meth)acrylate.

18. Hydrophilic immobilization layer in accordance with claim 14, wherein the softeners include at least one of Mono, Di and Triethyleneglycol.

19. Hydrophilic immobilization layer in accordance with claim 2, wherein the initial composition is present in a polar solvent mixable with water.

20. Hydrophilic immobilization layer in accordance with claim 2, wherein the layer is created on at least one of transducer and carrier surfaces made from at least one of metal, glass, silicon, silicon dioxide, silicon nitride, plastic and on surfaces with topography.
